(19) United States
(12) Patent Application Publication
(10) Pub. No.: US 2026/0352305 A1
(43) Pub. Date: Nov. 5, 2026

(54) BUTSON-TYPE PRECODING FOR WIRELESS MESSAGES

(71) Applicant: QUALCOMM Incorporated, San Diego, CA (US)

(72) Inventors: Chih-Hao LIU, San Diego, CA (US); Jing SUN, San Diego, CA (US); Tzu-Hsuan CHOU, San Diego, CA (US); Yu ZHANG, San Diego, CA (US)

(21) Appl. No.: 19/563,533

(22) Filed: Mar. 11, 2026

Related U.S. Application Data
(60) Provisional application No. 63/799,117, filed on May 2, 2025.

(51) Int. Cl. H04B 7/06; H04B 7/0413; H04B 17/318; H04L 27/26

(52) U.S. Cl. CPC H04B 7/0639; H04B 7/0413; H04B 17/328; H04L 27/2628

(57) ABSTRACT

Various aspects of the present disclosure generally relate to wireless communication. In some aspects, a receiver device may receive, from a transmitter device, control information that indicates a Butson-type precoder used to encode one or more wireless messages for transmission via a transmission channel. The receiver device may receive, from the transmitter device via the transmission channel, a wireless message from the one or more wireless messages. The receiver device may decode the wireless message in accordance with the Butson-type precoder indicated by the control information. Numerous other aspects are described.

### CROSS-REFERENCE TO RELATED APPLICATION

This Patent application claims priority to U.S. Provisional Patent Application No. 63/799,117, filed on May 2, 2025, entitled “BUTSON-TYPE PRECODING FOR WIRELESS MESSAGES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with Butson-type precoding for wireless messages.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a receiver device. The receiver device may include a processing system. The processing system may include one or more processors and one or more code-storing memories coupled with the one or more processors. The processing system may be configured to cause the receiver device to receive, from a transmitter device, control information that indicates a Butson-type precoder used to encode one or more wireless messages for transmission via a transmission channel. The processing system may be configured to cause the receiver device to receive, from the transmitter device via the transmission channel, a wireless message from the one or more wireless messages. The processing system may be configured to cause the receiver device to decode the wireless message in accordance with the Butson-type precoder indicated by the control information.

Some aspects described herein relate to a transmitter device. The transmitter device may include a processing system. The processing system may include one or more processors and one or more code-storing memories coupled with the one or more processors. The processing system may be configured to cause the transmitter device to transmit, to a receiver device, control information that indicates a Butson-type precoder used to encode one or more wireless messages for transmission via a transmission channel. The processing system may be configured to cause the transmitter device to encode a wireless message from the one or more wireless messages in accordance with the Butson-type precoder indicated by the control information. The processing system may be configured to cause the transmitter device to transmit, to the receiver device via the transmission channel, the wireless message.

Some aspects described herein relate to a method of wireless communication performed by a receiver device. The method may include receiving, from a transmitter device, control information that indicates a Butson-type precoder used to encode one or more wireless messages for transmission via a transmission channel. The method may include receiving, from the transmitter device via the transmission channel, a wireless message from the one or more wireless messages. The method may include decoding the wireless message in accordance with the Butson-type precoder indicated by the control information.

Some aspects described herein relate to a method of wireless communication performed by a transmitter device. The method may include transmitting, to a receiver device, control information that indicates a Butson-type precoder used to encode one or more wireless messages for transmission via a transmission channel. The method may include encoding a wireless message from the one or more wireless messages in accordance with the Butson-type precoder indicated by the control information. The method may include transmitting, to the receiver device via the transmission channel, the wireless message.

Some aspects described herein relate to a non-transitory computer-readable medium that stores a set of instructions for wireless communication by a receiver device. The set of instructions, when executed by one or more processors of the receiver device, may cause the receiver device to receive, from a transmitter device, control information that indicates a Butson-type precoder used to encode one or more wireless messages for transmission via a transmission channel. The set of instructions, when executed by one or more processors of the receiver device, may cause the receiver device to receive, from the transmitter device via the transmission channel, a wireless message from the one or more wireless messages. The set of instructions, when executed by one or more processors of the receiver device, may cause the receiver device to decode the wireless message in accordance with the Butson-type precoder indicated by the control information.

Some aspects described herein relate to a non-transitory computer-readable medium that stores a set of instructions for wireless communication by a transmitter device. The set of instructions, when executed by one or more processors of the transmitter device, may cause the transmitter device to transmit, to a receiver device, control information that indicates a Butson-type precoder used to encode one or more wireless messages for transmission via a transmission channel. The set of instructions, when executed by one or more processors of the transmitter device, may cause the transmitter device to encode a wireless message from the one or more wireless messages in accordance with the Butson-type precoder indicated by the control information. The set of instructions, when executed by one or more processors of the transmitter device, may cause the transmitter device to transmit, to the receiver device via the transmission channel, the wireless message.

Some aspects described herein relate to an apparatus for wireless communication. The apparatus may include means for receiving, from a transmitter device, control information that indicates a Butson-type precoder used to encode one or more wireless messages for transmission via a transmission channel. The apparatus may include means for receiving, from the transmitter device via the transmission channel, a wireless message from the one or more wireless messages. The apparatus may include means for decoding the wireless message in accordance with the Butson-type precoder indicated by the control information.

Some aspects described herein relate to an apparatus for wireless communication. The apparatus may include means for transmitting, to a receiver device, control information that indicates a Butson-type precoder used to encode one or more wireless messages for transmission via a transmission channel. The apparatus may include means for encoding a wireless message from the one or more wireless messages in accordance with the Butson-type precoder indicated by the control information. The apparatus may include means for transmitting, to the receiver device via the transmission channel, the wireless message.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of physical channels and reference signals in a wireless network.

FIG. 3 is a diagram illustrating an example of wireless message precoding and demapping.

FIG. 4 is a diagram illustrating an example in accordance with Butson-type precoding techniques to optimize transmission and reception.

FIG. 5 is a diagram illustrating an example associated with signaling that enables Butson-type encoding and decoding for wireless messages.

FIG. 6 is a diagram illustrating an example process performed, for example, at a receiver device or an apparatus of a receiver device.

FIG. 7 is a diagram illustrating an example process performed, for example, at a transmitter device or an apparatus of a transmitter device.

FIG. 8 is a diagram of an example apparatus for wireless communication.

FIG. 9 is a diagram of an example apparatus for wireless communication.

### DETAILED DESCRIPTION

Multiple-input, multiple-output (MIMO) communication systems utilize multiple antennas at both a transmitter and a receiver to enable transmission across multiple layers or spatial streams. MIMO technology may be used to increase data throughput, improve spectral efficiency, and enhance overall system performance. In MIMO systems, precoding techniques are employed at the transmitter to shape the transmitted signals across the layers, ensuring optimal reception at the receiver. Precoding can also mitigate interference between layers and improve signal quality at the receiver.

In wireless communication systems, the number of codewords supported by MIMO transmissions may be dependent on the number of spatial layers. For up to four layers, a single codeword may be supported, while for more than four layers, up to two codewords can be utilized. This configuration simplifies hardware implementation and reduces control signaling overhead. However, the use of a single codeword for multiple layers may introduce a layer quality imbalance, particularly in scenarios where the signal-to-noise ratio (SNR) across the layers is uneven. Layer imbalance can occur due to variations in channel quality across layers, which may result in weaker layers with lower SNRs dominating the decoding performance. This issue becomes particularly pronounced for high coding rate cases, where decoding performance is dictated by the weakest layer, leading to suboptimal utilization of channel capacity.

For a low-cost or low-capability user equipment (UE), the inability to deploy advanced nonlinear demappers or successive interference cancellation (SIC) mechanisms exacerbates the layer quality imbalance in MIMO precoding systems. Without effective methods to equalize SNRs across layers, a receiver device may experience degraded decoding performance, particularly in high-throughput applications or scenarios involving more than four layers. Additionally, the correlated nature of noise across layers in conventional MIMO precoding schemes further impacts decoding performance, as many forward error correction (FEC) techniques, such as low-density parity-check (LDPC) decoding, assume uncorrelated noise inputs. Accordingly, technical challenges related to layer imbalance in MIMO precoding systems may include one or more of ensuring equalized SNR across layers without utilizing complex receiver implementations, mitigating correlated noise across layers to facilitate effective FEC decoding, or providing scalable precoding techniques that can adapt to varying numbers of layers while maintaining computational efficiency.

Various aspects relate generally to mitigating layer imbalance in MIMO precoding systems for low-capability receiver devices. Some aspects more specifically relate to employing a Butson-type precoder at the transmitter and decoding the wireless message at the receiver in accordance with the indicated Butson-type precoder. The receiver device may receive control information from the transmitter device that identifies the specific Butson-type precoder applied to encode wireless messages and may use this information to decode the received wireless message. The decoding process includes applying a minimum mean square error (MMSE) equalizer to the wireless message based on a singular value decomposition (SVD) precoder, and subsequently transforming the resulting precoded signal using the Hermitian of the Butson-type precoder.

In some aspects, the Butson-type precoder may be selected from a codebook comprising one or more classes of matrices, such as discrete Fourier transform (DFT) matrices, inverse discrete Fourier transform (IDFT) matrices, real or complex Hadamard matrices, or quaternary Butson matrices. These matrices may be configured to equalize SNRs across multiple layers of the transmission channel, ensuring consistent decoding performance across all layers. The codebook may facilitate scalable precoding for varying numbers of spatial layers, making the Butson-type precoder adaptable to different MIMO system configurations. Additionally, the wireless message may include demodulation reference signals (DMRSs) precoded by both the Butson-type precoder and the SVD precoder, enabling accurate channel estimation and decoding.

Particular aspects of the subject matter described in this disclosure can be implemented to realize one or more of the following potential advantages. By introducing the Butson-type precoder, the described techniques can be used to equalize SNRs across layers in a MIMO system, addressing layer imbalance problems without utilizing complex nonlinear demapping or successive interference cancellation mechanisms. This enables low-capability receiver devices (which may only support MMSE demappers) to achieve computationally efficient decoding performance without requiring additional processing resources for advanced interference cancellation mechanisms. In this way, the wireless communications system may conserve processing resources by reducing the computational complexity of the decoding process. Furthermore, equalizing SNRs minimizes the impact of weaker layers on overall decoding performance, particularly in high coding rate cases, enabling more effective utilization of channel capacity. In some aspects, by employing the Butson-type precoder codebook, the wireless communications system can support scalable and computationally efficient precoding techniques for varying numbers of spatial layers. This adaptability ensures consistent decoding efficiency across different MIMO configurations, such as those used in fixed wireless access (FWA) applications. By mitigating correlated noise across layers, the described techniques facilitate effective FEC decoding, such as LDPC decoding, which assumes white noise inputs. In this way, the system may improve decoding robustness while minimizing computational resources required for error correction processes. Additionally, the Hermitian transformation of the precoded signal ensures that the decoded wireless message aligns with the content of the transmitted message, while maintaining low implementation complexity. This process enables cost-sensitive devices to execute decoding operations efficiently, conserving processing resources and reducing hardware requirements.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

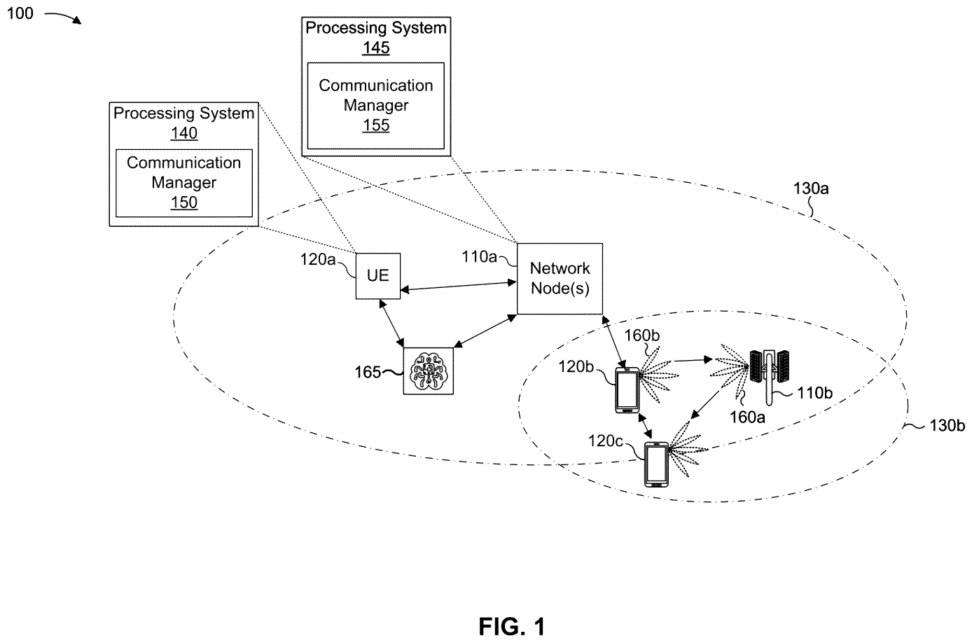

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the receiver device (e.g., a UE 120 or a network node 110) may include a communication manager 150 or a communication manager 155. As described in more detail elsewhere herein, the communication manager 150 or the communication manager 155 may receive, from a transmitter device, control information that indicates a Butson-type precoder used to encode one or more wireless messages for transmission via a transmission channel; receive, from the transmitter device via the transmission channel, a wireless message from the one or more wireless messages; and decode the wireless message in accordance with the Butson-type precoder indicated by the control information. Additionally, or alternatively, the communication manager 150 or the communication manager 155 may perform one or more other operations described herein.

In some aspects, the transmitter device (e.g., a UE 120 or a network node 110) may include a communication manager 150 or a communication manager 155. As described in more detail elsewhere herein, the communication manager 150 or the communication manager 155 may transmit, to a receiver device, control information that indicates a Butson-type precoder used to encode one or more wireless messages for transmission via a transmission channel; encode a wireless message from the one or more wireless messages in accordance with the Butson-type precoder indicated by the control information; and transmit, to the receiver device via the transmission channel, the wireless message. Additionally, or alternatively, the communication manager 150 or the communication manager 155 may perform one or more other operations described herein.

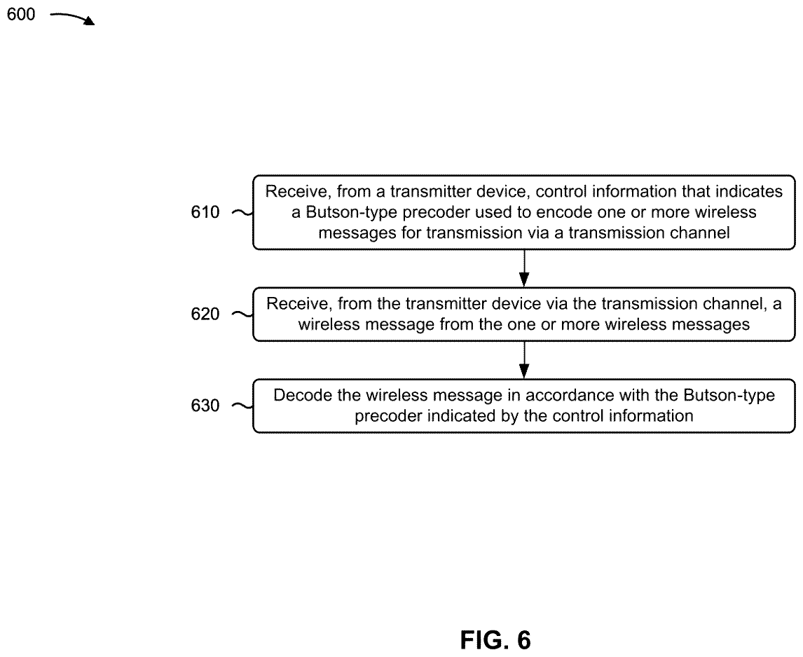

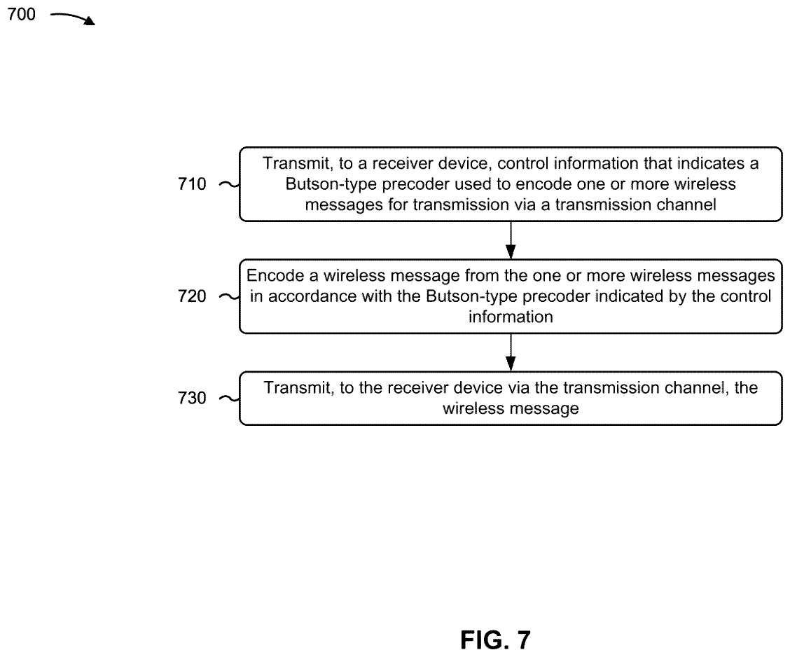

The network node 110, the processing system 145 of the network node 110, the UE 120, the processing system 140 of the UE 120, or any other component(s) of FIG. 1 may implement one or more techniques or perform one or more operations associated with Butson-type encoding and decoding for wireless messages, as described in more detail elsewhere herein. For example, the processing system 145 of the network node 110, or the processing system 140 of the UE 120 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

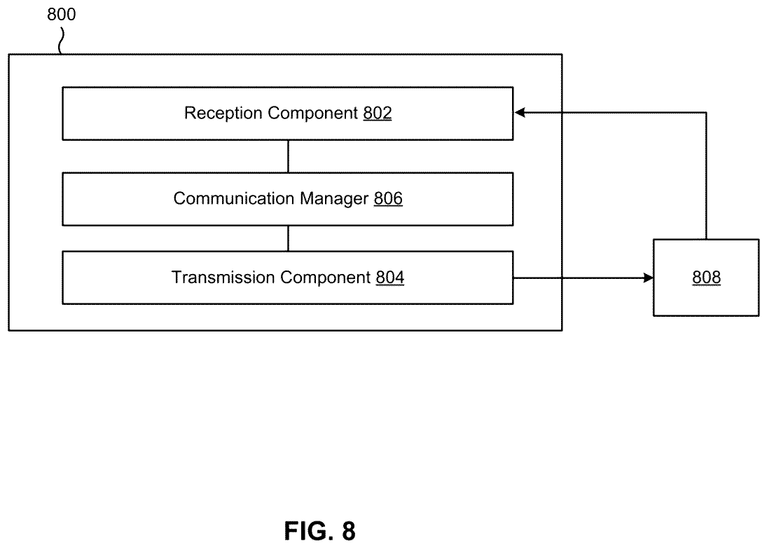

In some aspects, a receiver device (e.g., a UE 120 or a network node 110) includes means for receiving, from a transmitter device, control information that indicates a Butson-type precoder used to encode one or more wireless messages for transmission via a transmission channel; means for receiving, from the transmitter device via the transmission channel, a wireless message from the one or more wireless messages; or means for decoding the wireless message in accordance with the Butson-type precoder indicated by the control information. In some aspects, the means for the receiver device to perform operations described herein may include, for example, one or more of communication manager 150 or 155, processing system 140 or 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

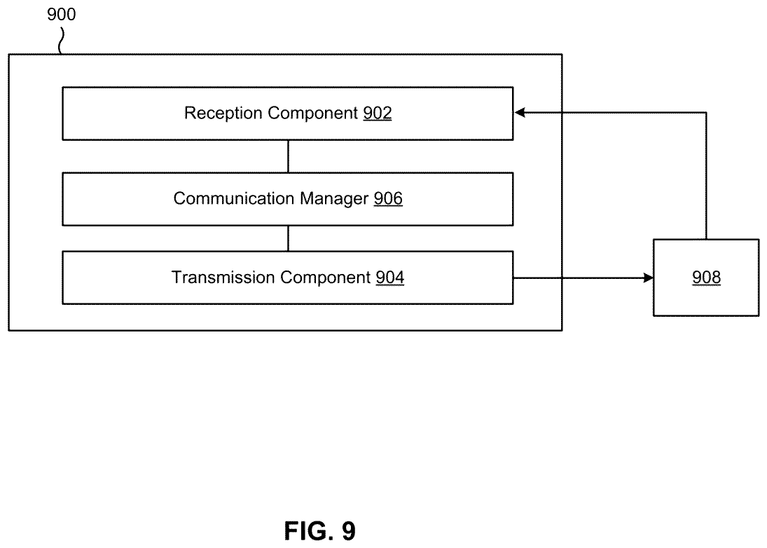

In some aspects, a transmitter device (e.g., a UE 120 or a network node 110) includes means for transmitting, to a receiver device, control information that indicates a Butson-type precoder used to encode one or more wireless messages for transmission via a transmission channel; means for encoding a wireless message from the one or more wireless messages in accordance with the Butson-type precoder indicated by the control information; or means for transmitting, to the receiver device via the transmission channel, the wireless message. In some aspects, the means for the transmitter device to perform operations described herein may include, for example, one or more of communication manager 150 or 155, processing system 140 or 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

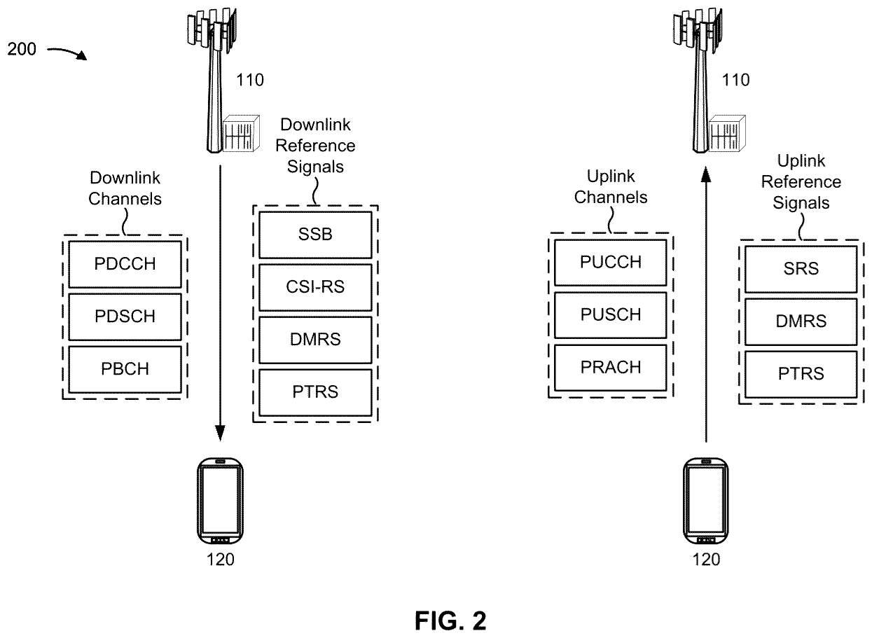

FIG. 2 is a diagram illustrating an example 200 of physical channels and reference signals in a wireless network. As shown in FIG. 2, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 2 is provided as an example. Other examples may differ from what is described with regard to FIG. 2.

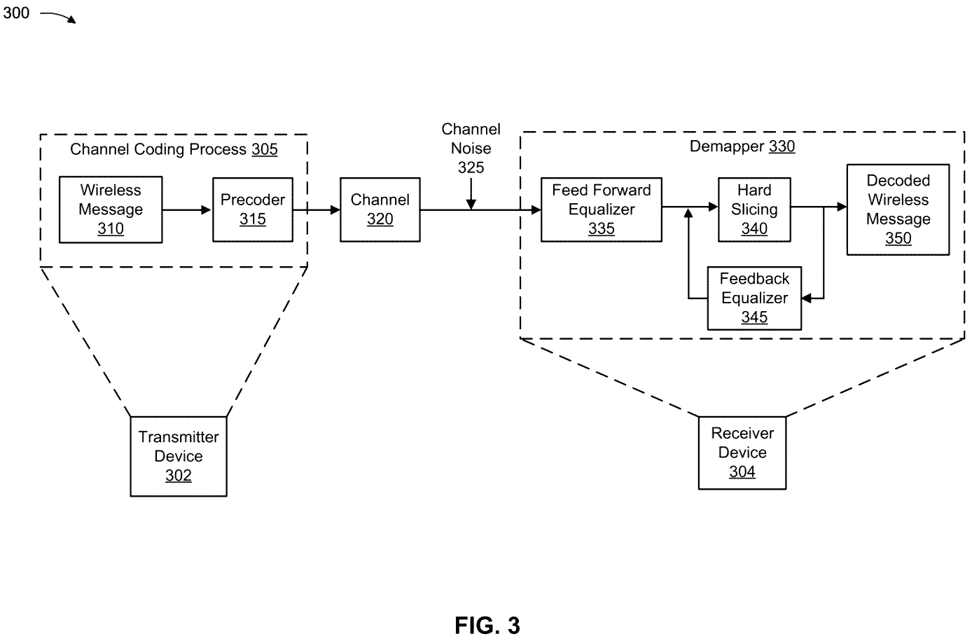

FIG. 3 is a diagram illustrating an example 300 of wireless message precoding and demapping. In some instances, example 300 may implement or be implemented by one or more aspects of FIGS. 1 through 3. For instance, FIG. 3 may illustrate wireless communications between the transmitter device 302 and the receiver device 304. In some examples, the transmitter device 302 receiver device 304 may be respective examples of any wireless device provided herein (e.g., the UE 120, the network node 110, among other examples).

In some examples, aspects of example 300 may support or be associated with MIMO precoding. For example, MIMO precoding may be categorized into codebook-based and non-codebook-based approaches. In some examples, codebook-based precoding may be associated with a predefined or preconfigured set of precoding matrices, or “codebooks” (e.g., defined in a wireless communications standard, such as 3GPP). Accordingly, the transmitter device 302 may select a precoding matrix from the set of precoding matrices based on feedback from the receiver device 304. For instance, the receiver device 304 may transmit a CSI report that indicates a PMI, guiding the transmitter device 302 in selecting the matrix that increases signal quality and reduces interference. Therefore, codebook-based MIMO precoding may increase computational efficiency at the transmitter device 302 and the receiver device 304, and reduce signaling overhead based on leveraging the predefined set of precoding matrices. In contrast, non-codebook-based precoding may increase flexibility by enabling the transmitter device 302 to compute precoding matrices dynamically, based on real-time channel state information. Therefore, non-codebook-based precoding may provide an increased adaptability to diverse and evolving channel environments but may increase computational complexity or signaling overhead.

In some examples, the transmitter device 302 may use one or more of codebook-based or non-codebook-based MIMO precoding to transmit a codeword. For example, a codeword may be an encoded representation of a wireless message 310 (e.g., a transport block). The codeword may include original data bits and additional redundancy bits introduced during a channel coding process 305 at the transmitter device 302. In some examples, the codeword may be the unit of data transmission over the physical layer, which may enable robustness against channel impairments (such as noise or interference). Therefore, transmission of the codeword by the transmitter device 302 enables the receiver device 304 to detect and correct errors, improving the reliability of communication.

In some examples, the transmitter device 302 may transmit one or more codewords concurrently in MIMO systems, in accordance with a rank of transmission. For instance, transmission of one codeword may be supported if the number of associated layers (e.g., spatial layers or spatial streams) is less than or equal to four. Additionally, concurrent transmission of up to two codewords may be supported if the number of associated spatial layers is greater than four. In some examples, the number of concurrent codeword transmissions via a number of MIMO spatial layers may be based on or in accordance with a hardware implementation at the transmitter device 302 or the receiver device 304. In some examples, any number of the codewords may be concurrently transmitted via any number of spatial layers.

In some examples, a set of MIMO spatial layers may be respectively associated with a set of signal quality values relative to a channel noise 325. With reference to example 300, signal quality of a spatial layer may be described with reference to SNR. However, in other implementations of example 300, “signal quality” may refer to one or more other signal quality metrics, such as one or more of reference signal received power (RSRP), reference signal received quality (RSRQ), signal-to-interference-plus-noise ratio (SINR), CQI, block error rate (BLER), bit error rate (BER), error vector magnitude (EVM), demodulation reference signal SINR (DMRS-SINR), or received signal strength indicator (RSSI).

In some examples, the channel coding process 305 may be associated with SVD precoding. For example, SVD precoding may decompose the channel matrix into a set of components that includes a first unitary matrix representing the transmitter device 302 spatial directions, a diagonal matrix that includes values associated with channel gain for each spatial layer, and a second unitary matrix associated with the receiver device 304 spatial directions. The SVD decomposition may enable the transmitter device 302 to precode data streams in alignment with a set of eigenmodes associated with a channel 320 used for transmission. In some examples, aligning the precoded data streams with the set of eigenmodes may respectively increase the SNR across the set of spatial layers, which may result in a different SNR associated with each spatial layer.

In accordance with codebook-based and non-codebook-based MIMO precoding, spatial layer SNR imbalance may reduce the quality of a codeword transmission. For example, in cases where a coding rate associated with transmission is above a coding rate threshold (e.g., a relatively high coding rate), decoding at the receiver device 304 may be relative to a spatial layer associated with the lowest SNR. In other words, decoding performance at the receiver device 304 may be limited by the lowest SNR across a set of MIMO spatial layers, which may reduce an ability of the receiver device 304 to decode the received codeword.

In some other examples, the channel coding process 305 may be associated with a precoding procedure that enables equalizing signal quality across a set of MIMO spatial layers. For example, the transmitter device 302 may use a precoder 315 associated with balancing SNR across the set of MIMO spatial layers. In some examples, the precoder 315 may be associated with geometric mean decomposition (GMD) precoding. For example, GMD may be associated with the transmitter device 302 transforming the channel matrix into a form that equalizes the SNR across multiple spatial layers, enabling balanced performance for all transmitted data streams. In some examples, the GMD precoding process may be associated with the transmitter device 302 receiving a CSI report from the receiver device 304 (such as through uplink feedback or reference signal measurements). In accordance with one or more CSI parameters included in the CSI report, the transmitter device 302 may perform a decomposition of the channel matrix into components that represent the spatial characteristics channel 320. Additionally, applying GMD may modify the decomposition such that each spatial layer experiences approximately the same effective SNR (e.g., the difference between the SNR of each spatial layer is less than a tolerance threshold). For example, if the number of spatial layers of the channel 320 is three, and the effective SNR is equal to 2, then a channel matrix H associated with the channel 320 may be in accordance with Equation 1:

$$H = [ \begin{matrix}\overline{λ} & 0 & 0 \\ 0 & \overline{λ} & 0 \\ 0 & 0 & \overline{λ}\end{matrix} ] \qquad ( 1 )$$

where the set of diagonal values of the channel matrix H are respectively associated with the set of spatial layers of the channel 320. That is, each column of the channel matrix H may be associated with a respective stream of the channel 320.

Additionally, determining the precoder 315 applied to the channel 320 may be associated with a decomposition of the channel matrix H in accordance with Equation 2:

$$H = {QRP}^{H} = Q [ \begin{matrix}\overline{λ} & * & * \\ ⋮ & ⋱ & * \\ 0 & … & \overline{λ}\end{matrix} ] {P}^{H} \qquad ( 2 )$$

For example, matrix Q and matrix P may both be examples of a unitary matrix. Additionally, the matrix P may be equal to the precoder 315 that the transmitter device 302 uses in accordance with GMD precoding. In some examples, the matrix R may be an N×N matrix, where N is the number of spatial layers of the channel 320. Additionally, the matrix R may be an upper triangular matrix, where each value across the diagonal of the matrix R is equal to λ̅ (e.g., the effective SNR for each spatial layer).

In some examples, the receiver device 304 may operate in accordance with a demapper 330 to decode the wireless message 310 that the transmitter device 302 transmitted in accordance with GMD precoding. In example 300, the demapper 330 may be associated with decision feedback equalization (DFE) demapping. In accordance with DFE demapping, the receiver device 304 may decompose the channel matrix using GMD to balance the SNR across spatial layers (e.g., in accordance with matrix Q and matrix R (QR) decomposition, with reference to Equation 2). In some examples, as part of DFE demapping, the receiver device 304 may apply a feed forward equalizer 335 to the received signal. For example, the feed forward equalizer 335 (e.g., G) may be defined in accordance with Equation 3:

$$G = \frac{1}{\overline{λ}} {Q}^{H} \qquad ( 3 )$$

After applying the feed forward equalizer 335, the receiver device 304 may decode the spatial layers of the received signal sequentially. For example, the receiver device 304 may begin with decoding a first spatial layer of the channel 320. The first spatial layer may be decoded in accordance with hard slicing 340. For example, the hard slicing 340 (in the context of demapping for GMD precoding) may include the process of directly mapping a received signal point in the QAM constellation to the nearest constellation symbol (e.g., without considering additional probabilistic or soft information about the signal). In QAM, each transmitted symbol may correspond to a specific point in the constellation, representing a combination of amplitude and phase. During the hard slicing 340, the demapper 330 examines the location of the received signal for the first spatial layer in the complex plane and assigns the location to the nearest valid symbol in the QAM constellation. In some examples, the hard slicing 340 may be computationally simple and fast compared to a process such as soft demapping based on the hard slicing 340 not accounting for channel impairments such as noise or interference beyond QAM distance measurements. Additionally, in systems employing GMD precoding (where SNR across spatial layers is equalized), the reliability associated with hard slicing may be increased based on the balanced SNR reducing the probability of incorrect symbol decisions.

In accordance with decoding the data associated with the first spatial layer of the channel 320, the receiver device 304 may use the decoded data to reconstruct and subtract the interference that the first spatial layer causes on the remaining spatial layers. For example, after decoding the data of the first spatial layer, the receiver device 304 may apply a feedback equalizer 345. The feedback equalizer 345 (e.g., B) may be defined in accordance with Equation 4:

$$B = ( \frac{1}{\overline{λ}} R - I ) \qquad ( 4 )$$

In accordance with applying feedback equalizer 345, the receiver device 304 may reduce the signal interference associated with the first spatial layer. Therefore, the receiver device 304 may continue with decoding the data associated with a second spatial layer of the channel 320. For instance, the receiver device 304 may perform the hard slicing 340 for the second spatial layer and then apply the feedback equalizer 345 to reduce the signal interference associated with the second spatial layer. In some examples, as part of DFE demapping, the receiver device 304 may iteratively perform the hard slicing 340 and the feedback equalizer for each spatial layer of the channel 320. Accordingly, the receiver device 304 may generate a decoded wireless message 350 in accordance with the demapper 330.

By leveraging GMD to equalize SNR across spatial layers, DFE demapping operates in a reduced error-prone environment, improving an effectiveness of DFE demapping. Additionally, the use of the feedback equalizer 345 in DFE demapping may allow the receiver device 304 to account for inter-spatial layer dependencies dynamically. Additionally, GMD precoding may balance SNR across spatial layers of the channel 320, which ensures that no single spatial layer dominates or becomes excessively weak, enhancing the overall reliability of the DFE demapping process. Therefore, the combination of GMD precoding and DFE demapping enables efficient and robust decoding of MIMO transmissions between the transmitter device 302 and the receiver device 304.

With reference to example 300, the transmitter device 302 and receiver device 304 may operate in accordance with GMD precoding. However, in other implementations, the transmitter device 302 and receiver device 304 may operate in accordance with any type of precoding technique that balances or equalizes signal quality across the set of MIMO spatial layers associated with the channel 320. For instance, one or more aspects of example 300 may be performed in accordance with uniform channel decomposition (UCD) based precoding. In some examples, UCD based precoding is a technique used in MIMO systems to balance the performance of spatial layers for efficient data transmission. In some examples, UCD is associated with decomposing the channel 320 into parallel subchannels with uniform capacities, which may enable each spatial layer to have comparable signal quality and reliability. This decomposition may allow the transmitter device 302 to allocate data streams evenly across the spatial layers, increasing throughput while maintaining balanced performance. UCD may be particularly effective in scenarios where a difference in channel conditions across spatial layers is above a difference threshold, as UCD may mitigate the disparities in SNR by enabling each spatial layer to have a similar effective channel quality. By achieving uniformity in the channel capacity, UCD based precoding reduces the risk of weaker spatial layers dominating decoding performance (e.g., spatial layers associated with lower SNR values).

With reference to example 300, the receiver device 304 may operate in accordance with GMD based decoding. However, in other implementations the receiver device 304 may operate in accordance with any type of decoding technique associated with balancing or equalizing signal quality across the set of MIMO spatial layers associated with the channel 320. For instance, the receiver device 304 may operate in accordance with partial successive reduction decoding (PSRD). In some examples, PSRD is associated with QR decomposition of the channel matrix H, which transforms the channel matrix H into two components (e.g., matrix Q and matrix R, as described with reference to Equation 2). Additionally, PSRD may incorporate or be associated with tree search algorithms (e.g., sphere decoding or K-best search) to identify highest probability symbol vectors of each data stream transmitted via the channel 320. Additionally, PSRD may incorporate or be associated with partial reduction where the receiver device 304 uses intermediate decisions of previously decoded spatial layers of the channel 320 to guide the search and decoding of subsequent spatial layers of the channel 320. In some cases, GMD or PSRD based decoding may initiate decoding on a last spatial layer of the channel 320 for each iteration of spatial layer decoding.

With reference to example 300, the receiver device 304 may operate in accordance with DFE demapping (e.g., using the demapper 330). However, in other implementations, the demapper 330 may use any demapping techniques associated with balancing or equalizing signal quality across the set of MIMO spatial layers associated with the channel 320. For example, the demapper 330 may use vertical Bell Laboratories spatial layered space-time (vBLAST) demapping or any QR based demapping.

In some examples, in addition to GMD precoding, the transmitter device may perform linear combination (LC)-MIMO mapping. LC-MIMO mapping is a technique used in wireless communication systems to enhance data transmission efficiency and reliability. LC-MIMO mapping involves the use of multiple antennas at both the transmitter and receiver to send and receive data streams simultaneously, leveraging spatial diversity to improve signal quality and reduce interference. “LC-MIMO mapping” specifically refers to the linear combination of these data streams, optimizing the allocation of resources across the available antennas to maximize throughput and minimize errors. This method is particularly beneficial in environments with high signal interference or multipath propagation, as LC-MIMO mapping can dynamically adjust to changing channel conditions. Additionally, the demapper 330 used at the receiver device 304 may be a code block (CB)-based MMSE successive interference cancellation (SIC) demapper. For example, a CB-based MMSE SIC demapper is a signal processing technique used in wireless communication systems to enhance data decoding accuracy. A CB-based MMSE SIC demapper operates by first applying MMSE filtering to minimize the mean square error between the received signal and the estimated signal, effectively reducing noise and interference. The SIC component then sequentially cancels out interference from previously decoded signals, allowing for more accurate decoding of subsequent signals. By focusing on code blocks, this demapper can efficiently handle complex signal environments, improving the reliability and throughput of data transmission. Accordingly, GMD precoding, LC-MIMO mapping, and the CB based MMSE SIC demapper enable an increase in performance for a single codeword across multiple spatial layers.

Therefore, based on the transmitter device 302 generating a precoder 315 associated with GMD or UCD precoding and the receiver device 304 operating in accordance with the demapper 330 associated with DFE, vBLAST, MMSE SIC, or some other QR decomposition based demapping, the SNRs across the spatial layers of channel 320 may be equalized or balanced, which may increase the data rate of the channel 320 relative to the Shannon capacity of the channel 320 (e.g., the theoretical maximum data rate that the channel 320 may achieve).

In some examples, however, the receiver device 304 may be unable to support one or more types of demapping schemes. For example, low capability UEs (such as IoT devices or simple eMTC modules) may be unable to support an MMSE SIC demapper, DFE demappers, or a nearly maximum likelihood demapper. Accordingly, in some examples, the receiver device 304 may only support an MMSE demapper. In contrast to a code-block-based MMSE SIC demapper (which combines MMSE filtering with successive interference cancellation and involves sequentially decoding and removing interference from previously decoded signals), the MMSE demapper uses a linear filter to minimize the mean square error between the estimated and actual transmitted signals, focusing on reducing noise and interference across the entire signal. Accordingly, the code-block-based MMSE SIC demapper may be more complex than the MMSE demapper based on utilizing additional processing to manage interference cancellation.

In examples where the receiver device 304 can only support MMSE demapping, the transmitter device 302 may use the SVD precoder for the precoder 315 and determine an additional layer mixing precoder to apply on top of the SVD precoder. For example, the layer mixing precoder may be a technique used in wireless communication systems to optimize the performance of SVD spatial layers by mitigating the impact of weaker layers. As described herein, when using SVD precoding, the overall system performance can be limited by the weakest spatial layer, which may have a lower signal quality due to channel impairments. The layer mixing precoder addresses this by intelligently combining or redistributing the data across the layers, ensuring that weaker layers do not disproportionately affect the system's throughput and reliability. This approach enhances the robustness and efficiency of the communication link, leading to improved data rates and more consistent performance across different channel conditions.

As indicated above, FIG. 3 is provided as an example. Other examples may differ from what is described with regard to FIG. 3.

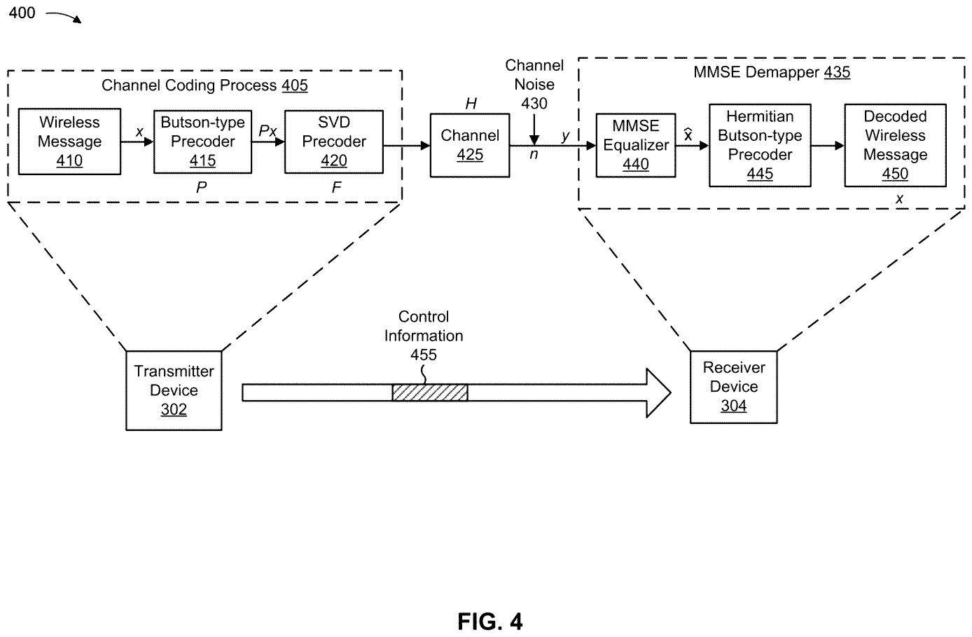

FIG. 4 is a diagram illustrating an example 400 in accordance with Butson-type precoding techniques to optimize transmission and reception. The example 400 comprises the transmitter device 302 and the receiver device 304, which communicate via a channel 425. The transmitter device 302 transmits control information 455, enabling the receiver device 304 to decode messages effectively.

In some examples, as part of a channel coding process 405, the transmitter device 302 may encode a wireless message 410 (x) using the SVD precoder 420 (F) for transmission on a channel 425 (H) that may include channel noise 430 (n) across the set of spatial layers of the channel 425. Accordingly, the received signal (y) of the wireless message 410 at the receiver device 304 may be in accordance with Equation 5:

y=HFx+n (5)

As shown in FIG. 4, the receiver device 304 may use an MMSE demapper 435 to derive the wireless message 410. As part of the MMSE demapper 435, the receiver device 304 may apply an MMSE equalizer 440 (Wₘₘₛₑ) to the received signal (y) in accordance with Equation 6:

$${W}_{mmse} = {( {\tilde{H}}^{H} \tilde{H} + {σ}_{n}^{2} I )}^{- 1} {\tilde{H}}^{H} \qquad ( 6 )$$

where \tilde{H}=HF, and the value of

$${σ}_{n}^{2}$$

per spatial layer of the channel 425. Additionally, for the SVD precoder 420 (F), svd(H)=USV^{H}. The matrix U is a unitary matrix that includes the left singular vectors of H, which represent the directions in the input space that are preserved by the channel 425. These vectors are orthogonal and span the column space of H. The matrix Sis a diagonal matrix where the diagonal elements are the singular values of H. These singular values may be non-negative, may be arranged in descending order, and may represent the magnitude of the transformation applied by the channel 425 in each corresponding direction defined by the singular vectors. The singular values provide insight into the gain of the channel 425. The matrix Vis another unitary matrix, including the right singular vectors of H. These vectors represent the directions in the output space that correspond to the left singular vectors in the input space. The matrix Vis used as SVD precoder 420 (e.g., F=V), optimizing the transmission by aligning the transmitted signals with the strongest spatial layers of the channel 425. Additionally, the matrix V^{H} is the Hermitian transpose of matrix V. Therefore, the MMSE equalizer 440 (Wₘₘₛₑ) may be further defined in accordance with Equation 7:

$${W}_{mmse} = {( {S}^{2} + {σ}_{n}^{2} I )}^{- 1} {SU}^{H} \qquad ( 7 )$$

By applying the MMSE equalizer 440 (Wₘₘₛₑ) to the received signal (y), the receiver device 304 may estimate the one or more QAM symbols (x) of the decoded wireless message 450, in accordance with Equation 8:

$$\hat{x} = {W}_{mmse} \cdot y = {( {S}^{2} + {σ}_{n}^{2} I )}^{- 1} {S}^{2} x + {( {S}^{2} + {σ}_{n}^{2} I )}^{- 1} {Sn}^{′} \qquad ( 8 )$$

where a noise (z) at the MMSE demapper 435 may be equal to the value of

$${( {S}^{2} + {σ}_{n}^{2} I )}^{- 1} {Sn}^{′} .$$

Additionally, an error covariance matrix (R_{zz}) of the noise (z) and a noise plus interference covariance matrix (Rₑₑ) may be respective defined in accordance with Equation 9 and Equation 10:

$${R}_{zz} = {( {S}^{2} + {σ}_{n}^{2} I )}^{- 2} {S}^{2} {σ}_{n}^{2} = {σ}_{n}^{2} [ \begin{matrix}\frac{{σ}_{h , 0}^{2}}{{( {σ}_{h , 0}^{2} + {σ}_{n}^{2} )}^{2}} & 0 & 0 \\ 0 & ⋱ & 0 \\ 0 & 0 & \frac{{σ}_{h , L - 1}^{2}}{{( {σ}_{h , L - 1}^{2} + {σ}_{n}^{2} )}^{2}}\end{matrix} ] \qquad ( 9 )$$

$${R}_{ee} = {σ}_{n}^{2} [ \begin{matrix}\frac{1}{{( {σ}_{h , 0}^{2} + {σ}_{n}^{2} / {σ}_{x}^{2} )}^{2}} & 0 & 0 \\ 0 & ⋱ & 0 \\ 0 & 0 & \frac{1}{{( {σ}_{h , L - 1}^{2} + {σ}_{n}^{2} / {σ}_{x}^{2} )}^{2}}\end{matrix} ] \qquad ( 10 )$$

where L is the number of spatial layers for the channel 425. With reference to Equation 9, the error covariance matrix (R_{zz}) quantifies the statistical properties of the estimation errors in the presence of noise at the MMSE demapper 435. In other words, the error covariance matrix (R_{zz}) represents the expected value of the outer product of the error vector, capturing how the noise affects different signal components of the received signal (y). This error covariance matrix (R_{zz}) enables the receiver device 304 to minimize the mean square error by appropriately weighting the received signal (y) based on the noise characteristics (z). In accordance with Equation 9, the weaker spatial layers of the channel 425 may have higher noise and therefore a lower SNR. Therefore, as the code rate increases for transmission of a given wireless message 410, the portions (e.g., code blocks) of the given wireless message 410 transmitted in weaker spatial layers may dominate the performance in the receiver device 304 decoding the wireless message 410.

With reference to Equation 10, the noise plus interference covariance matrix (Rₑₑ) quantifies the statistical properties of the estimation errors in the presence of noise and interference at the MMSE demapper 435. In other words, the noise plus interference covariance matrix (Rₑₑ) represents the expected value of the outer product of the error vector, capturing how the noise and interference affects different signal components of the received signal (y). This noise plus interference covariance matrix (Rₑₑ) enables the receiver device 304 to minimize the mean square error by appropriately weighting the received signal (y) based on the noise and interference characteristics (e). In accordance with Equation 10, the weaker spatial layers of the channel 425 may have higher noise and interference and therefore a lower SINR. Therefore, as the code rate increases for transmission of a given wireless message 410, the portions (e.g., code blocks) of the given wireless message 410 transmitted in weaker spatial layers may dominate the performance in the receiver device 304 decoding the wireless message 410.

In accordance with the techniques described herein, the transmitter device 302 may encode the wireless message 410 using a Butson-type precoder 415 in addition to the SVD precoder 420.

For instance, a complex Hadamard matrix of the Butson-type (e.g., H(q, N)) is a class of matrices where each element is a power of the q^{th} root of unity. These Butson-type matrices are characterized by orthogonal rows and columns, maintaining constant magnitude for all elements, which are derived from the complex roots of unity. In other words, (Hⱼₖ)^{q}=1 for all values of j and k in a Butson-type matrix. In one example, where q=4, the elements of the Butson-type matrix are ±1, ±j and no complex multiplication is used. In some examples, in-phase (I) and quadrature (Q) components of a Butson-type matrix may be swapped for multiplication (e.g., IQ swapping). “IQ swapping” refers to the interchange of I and Q components in signal processing, particularly in the context of complex signals. This operation involves swapping the real and imaginary parts of a complex vector or matrix, which can affect the phase and amplitude characteristics of the signal. In one example, a Butson-type matrix of H(4,4) may be an example of a 4×4 DFT matrix. In another example, a Butson-type matrix of H(4,6) is shown in Equation 11:

$$H ( 4 , 6 ) = [ \begin{matrix}1 & 1 & 1 & 1 & 1 & 1 \\ 1 & - 1 & j & - j & - j & j \\ 1 & j & - 1 & j & - j & - j \\ 1 & - j & j & - 1 & j & - j \\ 1 & - j & - j & j & - 1 & j \\ 1 & j & - j & - j & j & - 1\end{matrix} ] \qquad ( 11 )$$

Butson-type matrices similar to that of Equation 11 (e.g., where q=4) may be constructed by swapping one or more columns and rows or multiplying one or more columns or rows with a value of ±1 or ±j.

In some examples, the Butson-type precoder 415 may be an example of a DFT matrix. In some examples, the Butson-type precoders 415 may be real or complex Hadamard matrices and quaternary Butson matrices with {±1, ±j} (e.g., a Butson-type matrix of H (q=4,N), where the value of Nis equal to the number of spatial layers of the channel 425). For a Butson-type matrix H (q=4,N), there may be different numbers of permutations (or classes) of the Butson-type matrix based on the value of N, as shown in Table 1:

TABLE 1

| Number of Spatial Layers (N) | Number of Classes for H(q = 4, N) |
|---|---|
| 1 | 1 |
| 2 | 1 |
| 4 | 2 |
| 6 | 1 |
| 8 | 15 |
| 10 | 10 |
| 12 | 319 |
| 14 | 752 |

Additionally, as shown in FIG. 4, the Butson-type precoder 415 is a Butson-type Hadamard matrix P. Accordingly, matrix P∈C^{N×N} satisfies PP^{H}=I and

$$\vert {P}_{i , j} \vert = \frac{1}{\sqrt{N}}$$

(e.g., where N is the number of spatial layers of channel 425). Furthermore, the matrix P can equalize the diagonal elements of a diagonal matrix D=diag(d₀, d₁, . . . , d_{N-1}). In other words, PDP^{H}=A and

$${A}_{i , i} = \frac{1}{N} {\sum }_{k} {d}_{k} .$$

In some examples, the transmitter device 302 may apply the Butson-type precoder 415 to the wireless message 410 prior to applying the SVD precoder 420 (e.g., apply the Butson-type precoder 415 on top of the SVD precoder 420). Additionally, if the transmitter device 302 applies the Butson-type precoder 415, then the receiver device 304 may apply a Hermitian Butson-type precoder 445 to the output of the MMSE equalizer 440. For example, the Hermitian Butson-type precoder 445 may be a Hermitian of matrix P (e.g., matrix P^{H}). In other words, the output of the MMSE equalizer (assuming an SVD precoded channel) may be inverted by matrix P^{H}.

The matrix P^{H} can equalize the noise across the spatial layers of the channel 425 such that the per spatial layer SNRs are equal. In other words, applying the matrix P^{H} and the matrix P to the error covariance matrix (R_{zz}) can equalize the SNR across the spatial layers, in accordance with Equation 12:

$${P}^{H} {R}_{zz} P = {σ}_{n}^{2} \cdot \frac{1}{L} \sum {d}_{l} [ \begin{matrix}1 & x & x \\ x & ⋱ & x \\ x & x & 1\end{matrix} ] , where {d}_{l} = \frac{{σ}_{h , l}^{2}}{{( {σ}_{h , l}^{2} + {σ}_{n}^{2} )}^{2}} \qquad ( 12 )$$

Additionally, applying the matrix P^{H} and the matrix P to noise plus interference covariance matrix (Rₑₑ) can equalize the SINR across the spatial layers, in accordance with Equation 13:

$${P}^{H} {R}_{ee} P = {σ}_{n}^{2} \cdot \frac{1}{L} \sum {d}_{l} [ \begin{matrix}1 & x & x \\ x & ⋱ & x \\ x & x & 1\end{matrix} ] , where {d}_{l} = \frac{1}{{( {σ}_{h , l}^{2} + {σ}_{n}^{2} / {σ}_{x}^{2} )}^{2}} \qquad ( 13 )$$

Accordingly, the transmitter device 302 may use the Butson-type precoder 415 to layer mix the SVD precoded spatial layers for the wireless message 410. The wireless message 410 may be a PUSCH transmission (e.g., the transmitter device 302 is a UE 120 and the receiver device 304 is a network node 110), may be a PDSCH transmission (e.g., the transmitter device 302 is a network node 110 and the receiver device 304 is a UE 120), or may be a physical sidelink shared channel 425 (PSSCH) transmission (e.g., the transmitter device 302 is a first UE 120 and the receiver device 304 is a second UE 120), among other examples. The Butson-type precoder 415 includes one or more classes of one or more DFT matrices, one or more IDFT matrices, one or more real or complex Hadamard matrices, or one or more Butson-type quaternary complex matrices, among other examples.

A DFT matrix is a complex-valued matrix used to perform the discrete Fourier transform operation on a sequence of data points. Each element of a DFT matrix is a power of a complex root of unity. The DFT matrix is unitary, meaning the conjugate transpose is also the inverse of the DFT matrix, which allows the DFT matrix to preserve the energy of the transformed signal. An IDFT matrix is used to perform the inverse operation of the discrete Fourier transform, converting frequency-domain data back into the time domain. The elements of an IDFT matrix are powers of the complex root of unity. Similar to the DFT matrix, the IDFT matrix is also unitary, meaning that the conjugate transpose is the inverse of the IDFT matrix, which ensures that the transformation preserves the energy of the signal. A real or complex Hadamard matrix is a square matrix whose elements are either +1 or −1 (or whose elements are +j or −j) and whose rows are mutually orthogonal, meaning the dot product of any two distinct rows is zero. This orthogonality property ensures that the real or complex Hadamard matrix multiplied by the transpose of the real or complex Hadamard matrix results in a scaled identity matrix (e.g., nI, where n is the order of the real or complex Hadamard matrix). A quaternary Butson matrix is a type of complex Hadamard matrix where each element is a power of the fourth root of unity. These matrices are characterized by orthogonal rows and columns, meaning that the dot product of any two distinct rows or columns is zero.

In some examples, a wireless communications standard (such as 3GPP) may define a codebook (e.g., a Butson precoder codebook) that includes various types of matrices tailored for different numbers of spatial layers (N) in a wireless communication system. This codebook may be designed to provide flexibility and optimization in signal processing by offering a selection of matrices that can be applied depending on the number of spatial layers involved. These DFT/IDFT matrices may be included in the codebook for all values of N spatial layers, providing a universal option for transforming signals between the time and frequency domains. Their availability for any number of spatial layers makes DFT/IDFT matrices a versatile choice for a wide range of applications within the 3GPP standard, supporting efficient signal modulation and demodulation processes. The real or complex Hadamard matrices may be available in the codebook for specific values of N (e.g., N=2, 4, 8, 12, or 16). Within the context of wireless communications standards, the real or complex Hadamard matrices offer benefits in terms of orthogonality and signal energy preservation for systems operating with these specific layer counts, enhancing error correction and signal robustness. The quaternary Butson matrices may be included in the codebook for N values of 2, 4, 6, 8, 10, 12, and 14. The inclusion of quaternary Butson matrices in the codebook provides additional options for systems that can leverage the complex structure and orthogonal properties of Butson matrices, particularly in scenarios involving complex signal modulation and multiplexing. By including various options for the Butson-type precoder 415 in the codebook, the transmitter device 302 can select the most appropriate matrix type based on the number of layers and the specific characteristics of the wireless communication. This approach allows for optimized signal processing, improved robustness against noise, and efficient encoding and decoding of information across various system configurations, thereby enhancing the overall performance and reliability of wireless communication networks.

As part of the channel coding process 405, the transmitter device 302 may apply the Butson-type precoder 415 and then apply the SVD precoder 420 to the wireless message 410. Accordingly, the transmitter device 302 may transmit, and the receiver device 304 may receive, the encoded wireless message 410 (e.g., the received signal (y)) via the channel 425 (e.g., that includes the channel noise 430).

As shown in FIG. 4, the receiver device 304 may use the MMSE demapper 435 to decode the received signal (y) to derive the decoded wireless message 450. By applying the MMSE equalizer 440 (Wₘₘₛₑ) to the received signal (y), the receiver device 304 may estimate the one or more QAM symbols (\hat{x}) of the wireless message 410, where the one or more QAM symbols (\hat{x}) include the Butson-type precoder 415 (P) in accordance with Equation 14:

$$\hat{x} = {W}_{mmse} \cdot y = {( {S}^{2} + {σ}_{n}^{2} I )}^{- 1} {S}^{2} Px + {( {S}^{2} + {σ}_{n}^{2} I )}^{- 1} {Sn}^{′} \qquad ( 14 )$$

As shown, Equation 14, is similar to Equation 8, but includes the matrix P based on the transmitter device 302 applying the Butson-type precoder 415 to the wireless message 410. Additionally, the wireless message 410 may include one or more DMRSs that are also encoded by the Butson-type precoder 415 (e.g., as part of the channel coding process 405). Accordingly, for the receiver device 304 to obtain the channel 425 (that is SVD precoded) used to construct the MMSE demapper 435, the receiver device 304 may need to know the Butson-type precoder 415 used by the transmitter device 302 to encode the wireless message 410. Accordingly, the transmitter device 302 may transmit, and the receiver device 304 may receive, control information 455. For example, the control information 455 may indicate the Butson-type precoder 415 used for encoding the wireless message 410. In some examples, the control information 455 includes an index pointing to the chosen Butson-type precoder 415 within the Butson precoder codebook. For example, the index may be a PMI from multiple PMIs included in the codebook, where the multiple PMIs respectively point to the multiple Butson-type precoders 415 included in the codebook. Accordingly, by receiving the index included in the control information 455, the receiver device 304 may identify the Butson-type precoder 415 from the Butson precoder codebook. In some examples, the control information 455 may be one or more of system information (e.g., including a master information block (MIB) or SIB), RRC signaling, MAC signaling (e.g., including one or more MAC-CEs), DCI signaling, UCI signaling, or sidelink control information (SCI) signaling.

As described herein, the receiver device 304 constructs or generates the MMSE equalizer 440 using the SVD precoder 420 used for precoding the channel 425. However, the DMRSs transmitted via the channel 425 are precoded by both the SVD precoder 420 and the Butson-type precoder 415. Accordingly, when the receiver device 304 receives the DMRSs (which are predefined and known sequences) the receiver device 304 may compare them with the expected reference signals to assess the effects of the channel 425. By analyzing the differences between the transmitted and received DMRSs, the receiver device 304 can estimate the characteristics of the channel 425, such as one or more of fading, phase shifts, or attenuation. This estimation process enables the receiver device 304 to construct an estimated channel (Ĥ) used to calculate the channel noise 430 and the SVD precoder 420 corresponding to the channel 425 (e.g., Ĥ=HF+n). Accordingly, after generating the estimated channel (Ĥ), the receiver device 304 may multiply the estimated channel by the matrix P^{H} such that the receiver device 304 may identify the SVD precoder 420 used by the transmitter device 302, and may generate the MMSE equalizer 440 to decode the received signal (y).

In the context of Butson precoding, after the received signal (y) has passed through the MMSE equalizer 440, one or more QAM symbols (x) remain precoded by the Butson matrix (P). To effectively demap the received signal (y), the receiver device 304 may multiply the output of the MMSE equalizer by the Hermitian (conjugate transpose) of the Butson precoding matrix (e.g., apply the Hermitian Butson-type precoder 445). The receiver device 304 may apply the Hermitian Butson-type precoder 445 because the MMSE equalizer 440 (constructed based on the channel 425 that is SVD precoded) does not fully remove the Butson precoding effects. The operation of undoing the Butson precoding serves to equalize the SNR across the different spatial layers, which may be advantageous when the wireless message 410 is a single code block or single codeword transmitted across multiple spatial layers. This equalization ensures that each spatial layer contributes equally to the overall signal quality, enhancing the robustness and efficiency of the communication system. Accordingly, applying the Hermitian Butson-type precoder 445 enables the receiver device 304 to derive the decoded wireless message 450 (x).

Optionally, the receiver device 304 may additionally perform an MMSE bias removal to further refine the signal before undoing the Butson precoding. For instance, after the initial MMSE equalization (e.g., using the MMSE equalizer 440), which aims to minimize the mean square error between the estimated and actual transmitted signals, a bias may still exist due to noise and imperfections of the channel 425. The bias removal step involves adjusting the equalized signal to correct any systematic errors introduced during the equalization process, thereby improving the fidelity of the signal reconstruction. This adjustment helps in achieving a more accurate representation of the transmitted signal, particularly in environments with high noise or interference levels. By removing the bias, the overall performance of the communication system is enhanced, leading to more reliable data transmission and reception.

As indicated above, FIG. 4 is provided as an example. Other examples may differ from what is described with regard to FIG. 4.

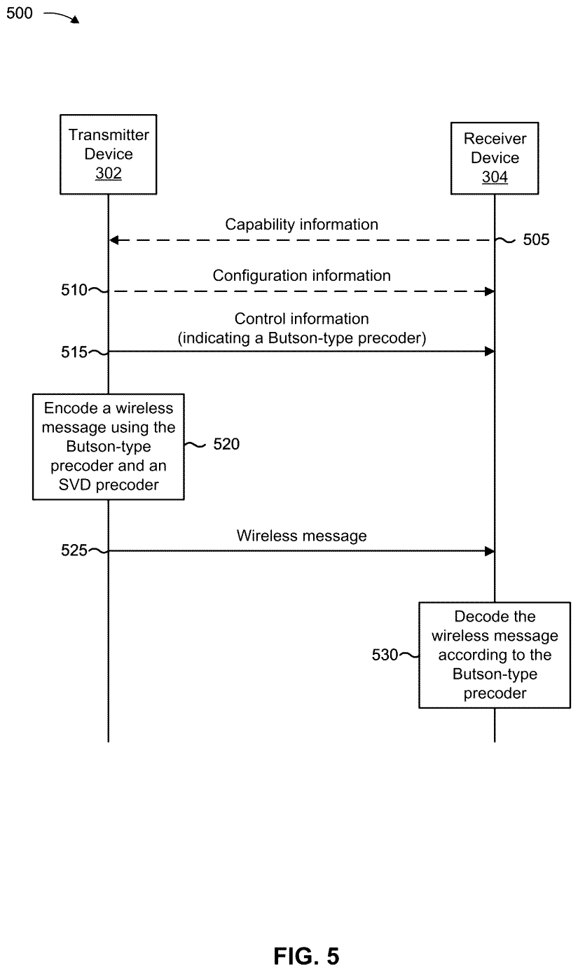

FIG. 5 is a diagram illustrating an example 500 associated with signaling that enables Butson-type encoding and decoding for wireless messages. Example 500 may implement or be implemented by one or more aspects provided herein, with reference to FIGS. 1 through 4. For instance, example 500 includes wireless communications between the transmitter device 302 and the receiver device 304. Alternative examples of the following may be implemented, where some operations are performed in a different order than described, or not described at all. In some cases, one or more operations may include additional features not mentioned below, or further operations may be added. In addition, while example 500 shows operations between the transmitter device 302 and the receiver device 304, the communications may occur between any number of network devices of various types described herein.

In a first operation 505, the receiver device 304 may optionally transmit, and the transmitter device 302 may receive, capability information. The capability information may be included in a capability report. The receiver device 304 may transmit the capability information via an uplink communication, a sidelink communication, a unicast communication, a broadcast communication, a UE assistance information (UAI) communication, a UCI communication, a SCI communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the receiver device 304. The one or more parameters may be indicated via respective information elements (IEs) included in a capability report.

The capability information may indicate whether the receiver device 304 supports a feature or one or more parameters related to the feature. For example, the capability information may indicate a capability of the receiver device 304 to support MMSE demapping. In other words, the capability information may indicate that the receiver device 304 is capable of operating in accordance with the MMSE demapper 435. In some examples, the capability information may implicitly indicate the support for MMSE demapping based on indicating a type of device for the receiver device 304 (e.g., a low-complexity UE). One or more operations described herein may be based on the capability information. For example, the receiver device 304 may perform one or more operations of example 500 in accordance with the capability information or may receive one or more of configuration information or control information that is in accordance with the capability information. The transmitter device 302 may determine configuration information for the receiver device 304 based on the capability information.

In a second operation 510, the transmitter device 302 may optionally transmit, and the receiver device 304 may receive, the configuration information. In some aspects, the receiver device 304 may receive the configuration information via one or more of system information signaling (e.g., a MIB or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the receiver device 304. For example, in some aspects, the configuration information may at least partially be defined by a wireless communication standard, such as the 3GPP. In such examples, the transmitter device 302 may not explicitly indicate such configuration information to the receiver device 304. For example, the receiver device 304 may optionally obtain at least a portion of the configuration information from a configuration stored by the receiver device 304 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may indicate the Butson precoder codebook, described herein. In some examples, the configuration information may enable the receiver device 304 to use the Butson precoder codebook to determine a Butson-type precoder used by the transmitter device 302 to encode one or more wireless messages.

In some examples, the Butson precoder codebook comprises one or more classes of matrices including one or more of one or more DFT matrices, one or more IDFT matrices, one or more real or complex Hadamard matrices, or one or more quaternary Butson matrices. Additionally, the one or more classes of matrices may be used for precoding wireless messages for transmission channels with different numbers of spatial layers.

In a third operation 515, the transmitter device 302 may transmit, and the receiver device 304 may receive, control information that indicates a Butson-type precoder (e.g., the Butson-type precoder 415) used to encode one or more wireless messages for transmission via a transmission channel (e.g., the channel 425). In some examples, the control information may be an example of the control information 455. For example, the control information may include an index (e.g., a PMI) that points to the Butson-type precoder from the Butson precoder codebook. As described herein, the Butson-type precoder may be configured to equalize SNRs across multiple spatial layers of the transmission channel.

In some other examples, rather than Butson-type precoder codebook, the wireless communications standard may define a single DFT/IDFT matrix for use as the Butson-type precoder (e.g., which may be configured at the receiver device 304 or transmitter device 302 via the configuration information). Accordingly, in such other examples, the control information may include an indication (e.g., a single bit) indicating whether the Butson-type precoder (e.g., the single DFT/IDFT matrix) is used to encode the one or more wireless messages. Accordingly, using a single DFT/IDFT matrix for the Butson-type precoder rather than the Butson-type precoder codebook may reduce complexity in implementing Butson-type encoding and decoding techniques and reduce signaling overhead in the control information for indicating of whether the Butson-type precoder is used for one or more wireless transmissions.

In some aspects, the receiver device 304 may receive the control information via one or more of system information signaling (e.g., a MIB or a SIB, among other examples), RRC signaling, MAC signaling (e.g., one or more MAC-CEs), DCI signaling, UCI signaling, or SCI signaling, among other examples.

In a fourth operation 520, the transmitter device 302 may encode a wireless message (e.g., the wireless message 410) in accordance with the Butson-type precoder (e.g., indicated by the control information). For example, the transmitter device 302 may perform one or more operations provided with reference to the channel coding process 405, such as applying the Butson-type precoder and an SVD precoder (e.g., the SVD precoder 420) to the wireless message.

In a fifth operation 525, the transmitter device 302 may transmit via the transmission channel, and the receiver device 304 may receive, the wireless message. In some examples, the wireless message includes one or more DMRSs precoded by the Butson-type precoder and by the SVD precoder. In some examples, the wireless message may be part of a single codeword transmission scheme in a MIMO system.

In a sixth operation 530, the receiver device 304 may decode the wireless message in accordance with the Butson-type precoder indicated by the control information. For example, the receiver device 304 may perform one or more operations provided with reference to the MMSE demapper 435. For instance, the receiver device 304 may apply an MMSE equalizer (e.g., the MMSE equalizer 440) to the wireless message based on the wireless message being precoded by the SVD precoder, where the MMSE equalizer outputs a precoded signal that is precoded by the Butson-type precoder. Additionally, the receiver device 304 may transform the precoded signal by a Hermitian of the Butson-type precoder (e.g., the Hermitian Butson-type precoder 445), where transforming the precoded signal results in a decoded version of the wireless message. In some examples, the receiver device 304 may additionally perform a bias removal operation prior to transforming the precoded signal by the Hermitian of the Butson-type precoder.

As indicated above, FIG. 5 is provided as an example. Other examples may differ from what is described with regard to FIG. 5.

FIG. 6 is a diagram illustrating an example process 600 performed, for example, at a receiver device or an apparatus of a receiver device. Example process 600 is an example where the apparatus or the receiver device (e.g., receiver device 304) performs operations associated with Butson-type precoding for wireless messages.

As shown in FIG. 6, in some aspects, process 600 may include receiving, from a transmitter device, control information that indicates a Butson-type precoder used to encode one or more wireless messages for transmission via a transmission channel (block 610). For example, the receiver device (e.g., using reception component 802 or communication manager 806, depicted in FIG. 8) may receive, from a transmitter device, control information that indicates a Butson-type precoder used to encode one or more wireless messages for transmission via a transmission channel, as described above.

As further shown in FIG. 6, in some aspects, process 600 may include receiving, from the transmitter device via the transmission channel, a wireless message from the one or more wireless messages (block 620). For example, the receiver device (e.g., using reception component 802 or communication manager 806, depicted in FIG. 8) may receive, from the transmitter device via the transmission channel, a wireless message from the one or more wireless messages, as described above.

As further shown in FIG. 6, in some aspects, process 600 may include decoding the wireless message in accordance with the Butson-type precoder indicated by the control information (block 630). For example, the receiver device (e.g., using communication manager 806, depicted in FIG. 8) may decode the wireless message in accordance with the Butson-type precoder indicated by the control information, as described above.

Process 600 may include additional aspects, such as any single aspect or any combination of aspects described below or in connection with one or more other processes described elsewhere herein.

In a first aspect, a Butson precoder codebook comprises the Butson-type precoder, and the Butson precoder codebook includes one or more classes of matrices comprising one or more of one or more discrete Fourier transform matrices, one or more inverse discrete Fourier transform matrices, one or more real or complex Hadamard matrices, or one or more quaternary Butson matrices.

In a second aspect, alone or in combination with the first aspect, the one or more classes of matrices are used for precoding for different numbers of spatial layers.

In a third aspect, alone or in combination with one or more of the first and second aspects, the control information includes an index that points to the Butson-type precoder from a Butson precoder codebook.

In a fourth aspect, alone or in combination with one or more of the first through third aspects, the wireless message includes a DMRS precoded by the Butson-type precoder and by an SVD precoder.

In a fifth aspect, alone or in combination with one or more of the first through fourth aspects, decoding the wireless message further comprises applying an MMSE equalizer to the wireless message based on the wireless message being precoded by an SVD precoder, wherein the MMSE equalizer outputs a precoded signal that is precoded by the Butson-type precoder.

In a sixth aspect, alone or in combination with one or more of the first through fifth aspects, decoding the wireless message further comprises transforming the precoded signal by a Hermitian of the Butson-type precoder, wherein transforming the precoded signal results in a decoded version of the wireless message.

In a seventh aspect, alone or in combination with one or more of the first through sixth aspects, a bias removal operation is performed prior to transforming the precoded signal by the Hermitian of the Butson-type precoder.

In an eighth aspect, alone or in combination with one or more of the first through seventh aspects, the Butson-type precoder is configured to equalize SNRs across multiple layers of the transmission channel.

In a ninth aspect, alone or in combination with one or more of the first through eighth aspects, the wireless message is part of a single codeword transmission scheme in a MIMO system.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a transmitter device or an apparatus of a transmitter device. Example process 700 is an example where the apparatus or the transmitter device (e.g., transmitter device 302) performs operations associated with Butson-type precoding for wireless messages.

As shown in FIG. 7, in some aspects, process 700 may include transmitting, to a receiver device, control information that indicates a Butson-type precoder used to encode one or more wireless messages for transmission via a transmission channel (block 710). For example, the transmitter device (e.g., using transmission component 904 or communication manager 906, depicted in FIG. 9) may transmit, to a receiver device, control information that indicates a Butson-type precoder used to encode one or more wireless messages for transmission via a transmission channel, as described above.

As further shown in FIG. 7, in some aspects, process 700 may include encoding a wireless message from the one or more wireless messages in accordance with the Butson-type precoder indicated by the control information (block 720). For example, the transmitter device (e.g., using communication manager 906, depicted in FIG. 9) may encode a wireless message from the one or more wireless messages in accordance with the Butson-type precoder indicated by the control information, as described above.

As further shown in FIG. 7, in some aspects, process 700 may include transmitting, to the receiver device via the transmission channel, the wireless message (block 730). For example, the transmitter device (e.g., using transmission component 904 or communication manager 906, depicted in FIG. 9) may transmit, to the receiver device via the transmission channel, the wireless message, as described above.

Process 700 may include additional aspects, such as any single aspect or any combination of aspects described below or in connection with one or more other processes described elsewhere herein.

In a first aspect, a Butson precoder codebook comprises the Butson-type precoder, and the Butson precoder codebook includes one or more classes of matrices comprising one or more of one or more discrete Fourier transform matrices, one or more inverse discrete Fourier transform matrices, one or more real or complex Hadamard matrices, or one or more quaternary Butson matrices.

In a second aspect, alone or in combination with the first aspect, the one or more classes of matrices are used for precoding for different numbers of spatial layers.

In a third aspect, alone or in combination with one or more of the first and second aspects, the control information includes an index that points to the Butson-type precoder from a Butson precoder codebook.

In a fourth aspect, alone or in combination with one or more of the first through third aspects, the wireless message includes a DMRS precoded by the Butson-type precoder and by an SVD precoder.

In a fifth aspect, alone or in combination with one or more of the first through fourth aspects, encoding the wireless message further comprises encoding the wireless message with an SVD precoder in addition to the Butson-type precoder, wherein the Butson-type precoder applies a layer mix to the SVD precoder.

In a sixth aspect, alone or in combination with one or more of the first through fifth aspects, the Butson-type precoder is configured to equalize SNRs across multiple layers of the transmission channel.

In a seventh aspect, alone or in combination with one or more of the first through sixth aspects, the wireless message is part of a single codeword transmission scheme in a MIMO system.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a receiver device, or a receiver device may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 or the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 or the processing system 145 described in connection with FIG. 1) of the receiver device.

In some aspects, the apparatus 800 may be configured to perform one or more operations described herein in connection with FIGS. 2 through 5. Additionally, or alternatively, the apparatus 800 may be configured to perform one or more processes described herein, such as process 600 of FIG. 6 In some aspects, the apparatus 800 or one or more components shown in FIG. 8 may include one or more components of the receiver device described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the receiver device described above in connection with FIG. 1, such as a radio, one or more RF chains, one or more transceivers, or one or more modems, each of which may in turn be coupled with one or more antennas of the receiver device.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the receiver device described above in connection with FIG. 1, such as a radio, one or more RF chains, one or more transceivers, or one or more modems, each of which may in turn be coupled with one or more antennas of the receiver device described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, from a transmitter device, control information that indicates a Butson-type precoder used to encode one or more wireless messages for transmission via a transmission channel. The reception component 802 may receive, from the transmitter device via the transmission channel, a wireless message from the one or more wireless messages. The communication manager 806 may decode the wireless message in accordance with the Butson-type precoder indicated by the control information.

In some examples, the communication manager 806 may apply an MMSE equalizer to the wireless message based on the wireless message being precoded by an SVD precoder, where the MMSE equalizer outputs a precoded signal that is precoded by the Butson-type precoder.

In some examples, the communication manager 806 may transform the precoded signal by a Hermitian of the Butson-type precoder, where transforming the precoded signal results in a decoded version of the wireless message.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a transmitter device, or a transmitter device may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 or the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 or the processing system 145 described in connection with FIG. 1) of the transmitter device.

In some aspects, the apparatus 900 may be configured to perform one or more operations described herein in connection with FIGS. 2 through 5. Additionally, or alternatively, the apparatus 900 may be configured to perform one or more processes described herein, such as process 700 of FIG. 7. In some aspects, the apparatus 900 or one or more components shown in FIG. 9 may include one or more components of the transmitter device described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the transmitter device described above in connection with FIG. 1, such as a radio, one or more RF chains, one or more transceivers, or one or more modems, each of which may in turn be coupled with one or more antennas of the transmitter device.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the transmitter device described above in connection with FIG. 1, such as a radio, one or more RF chains, one or more transceivers, or one or more modems, each of which may in turn be coupled with one or more antennas of the transmitter device described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a receiver device, control information that indicates a Butson-type precoder used to encode one or more wireless messages for transmission via a transmission channel. The communication manager 906 may encode a wireless message from the one or more wireless messages in accordance with the Butson-type precoder indicated by the control information. The transmission component 904 may transmit, to the receiver device via the transmission channel, the wireless message.

In some examples, the communication manager 906 may encode the wireless message with an SVD precoder in addition to the Butson-type precoder, wherein the Butson-type precoder applies a layer mix to the SVD precoder.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a receiver device, comprising: receiving, from a transmitter device, control information that indicates a Butson-type precoder used to encode one or more wireless messages for transmission via a transmission channel; receiving, from the transmitter device via the transmission channel, a wireless message from the one or more wireless messages; and decoding the wireless message in accordance with the Butson-type precoder indicated by the control information.

Aspect 2: The method of Aspect 1, wherein a Butson precoder codebook comprises the Butson-type precoder, and wherein the Butson precoder codebook includes one or more classes of matrices comprising one or more of: one or more discrete Fourier transform matrices, one or more inverse discrete Fourier transform matrices, one or more real or complex Hadamard matrices, or one or more quaternary Butson matrices.

Aspect 3: The method of Aspect 2, wherein the one or more classes of matrices are used for precoding for different numbers of spatial layers.

Aspect 4: The method of any of Aspects 1-3, wherein the control information includes an index that points to the Butson-type precoder from a Butson precoder codebook.

Aspect 5: The method of any of Aspects 1-4, wherein the wireless message includes a demodulation reference signal (DMRS) precoded by the Butson-type precoder and by a singular value decomposition (SVD) precoder.

Aspect 6: The method of any of Aspects 1-5, wherein decoding the wireless message further comprises: applying a minimum mean square error (MMSE) equalizer to the wireless message based on the wireless message being precoded by a singular value decomposition (SVD) precoder, wherein the MMSE equalizer outputs a precoded signal that is precoded by the Butson-type precoder.

Aspect 7: The method of Aspect 6, wherein decoding the wireless message further comprises: transforming the precoded signal by a Hermitian of the Butson-type precoder, wherein transforming the precoded signal results in a decoded version of the wireless message.

Aspect 8: The method of Aspect 7, wherein a bias removal operation is performed prior to transforming the precoded signal by the Hermitian of the Butson-type precoder.

Aspect 9: The method of any of Aspects 1-8, wherein the Butson-type precoder is configured to equalize signal-to-noise ratios (SNRs) across multiple layers of the transmission channel.

Aspect 10: The method of any of Aspects 1-9, wherein the wireless message is part of a single codeword transmission scheme in a multiple input multiple output (MIMO) system.

Aspect 11: A method of wireless communication performed by a transmitter device, comprising: transmitting, to a receiver device, control information that indicates a Butson-type precoder used to encode one or more wireless messages for transmission via a transmission channel; encoding a wireless message from the one or more wireless messages in accordance with the Butson-type precoder indicated by the control information; and transmitting, to the receiver device via the transmission channel, the wireless message.

Aspect 12: The method of Aspect 11, wherein a Butson precoder codebook comprises the Butson-type precoder, and wherein the Butson precoder codebook includes one or more classes of matrices comprising one or more of: one or more discrete Fourier transform matrices, one or more inverse discrete Fourier transform matrices, one or more real or complex Hadamard matrices, or one or more quaternary Butson matrices.

Aspect 13: The method of Aspect 12, wherein the one or more classes of matrices are used for precoding for different numbers of spatial layers.

Aspect 14: The method of any of Aspects 11-13, wherein the control information includes an index that points to the Butson-type precoder from a Butson precoder codebook.

Aspect 15: The method of any of Aspects 11-14, wherein the wireless message includes a demodulation reference signal (DMRS) precoded by the Butson-type precoder and by a singular value decomposition (SVD) precoder.

Aspect 16: The method of any of Aspects 11-15, wherein encoding the wireless message further comprises: encoding the wireless message with a singular value decomposition (SVD) precoder in addition to the Butson-type precoder, wherein the Butson-type precoder applies a layer mix to the SVD precoder.

Aspect 17: The method of any of Aspects 11-16, wherein the Butson-type precoder is configured to equalize signal-to-noise ratios (SNRs) across multiple layers of the transmission channel.

Aspect 18: The method of any of Aspects 11-17, wherein the wireless message is part of a single codeword transmission scheme in a multiple input multiple output (MIMO) system.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

Aspect 26: A device comprising a processing system that includes one or more processors and one or more code-storing memories coupled with the one or more processors, the processing system configured to cause the device to perform the method of one or more of Aspects 1-18.

Aspect 27: A device comprising a processing system that includes processor circuitry and code-storing memory circuitry, the processing system configured to cause the device to perform the method of one or more of Aspects 1-18.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A receiver device, comprising:
a processing system that includes one or more processors and one or more code-storing memories coupled with the one or more processors, the processing system configured to cause the receiver device to:
receive, from a transmitter device, control information that indicates a Butson-type precoder used to encode one or more wireless messages for transmission via a transmission channel;
receive, from the transmitter device via the transmission channel, a wireless message from the one or more wireless messages; and
decode the wireless message in accordance with the Butson-type precoder indicated by the control information.

2. The receiver device of claim 1, wherein a Butson precoder codebook comprises the Butson-type precoder, and wherein the Butson precoder codebook includes one or more classes of matrices comprising one or more of:
one or more discrete Fourier transform matrices,
one or more inverse discrete Fourier transform matrices,
one or more real Hadamard matrices, or
one or more quaternary Butson matrices.

3. The receiver device of claim 2, wherein the one or more classes of matrices are used for precoding for different numbers of spatial layers.

4. The receiver device of claim 1, wherein the control information includes an index that points to the Butson-type precoder from a Butson precoder codebook.

5. The receiver device of claim 1, wherein the wireless message includes a demodulation reference signal (DMRS) precoded by the Butson-type precoder and by a singular value decomposition (SVD) precoder.

6. The receiver device of claim 1, wherein the processing system, to cause the receiver device to decode the wireless message, is configured to cause the receiver device to:
apply a minimum mean square error (MMSE) equalizer to the wireless message based on the wireless message being precoded by a singular value decomposition (SVD) precoder, wherein the MMSE equalizer outputs a precoded signal that is precoded by the Butson-type precoder.

7. The receiver device of claim 6, wherein the processing system, to cause the receiver device to decode the wireless message, is configured to cause the receiver device to:
transform the precoded signal by a Hermitian of the Butson-type precoder, wherein transforming the precoded signal results in a decoded version of the wireless message.

8. The receiver device of claim 7, wherein a bias removal operation is performed prior to transforming the precoded signal by the Hermitian of the Butson-type precoder.

9. The receiver device of claim 1, wherein the Butson-type precoder is configured to equalize signal-to-noise ratios (SNRs) across multiple layers of the transmission channel.

10. The receiver device of claim 1, wherein the wireless message is part of a single codeword transmission scheme in a multiple input multiple output (MIMO) system.

11. A method of wireless communication performed by a receiver device, comprising:
receiving, from a transmitter device, control information that indicates a Butson-type precoder used to encode one or more wireless messages for transmission via a transmission channel;
receiving, from the transmitter device via the transmission channel, a wireless message from the one or more wireless messages; and
decoding the wireless message in accordance with the Butson-type precoder indicated by the control information.

12. The method of claim 11, wherein a Butson precoder codebook comprises the Butson-type precoder, and wherein the Butson precoder codebook includes one or more classes of matrices comprising one or more of:
one or more discrete Fourier transform matrices,
one or more inverse discrete Fourier transform matrices,
one or more real or complex Hadamard matrices, or
one or more quaternary Butson matrices.

13. The method of claim 12, wherein the one or more classes of matrices are used for precoding for different numbers of spatial layers.

14. The method of claim 11, wherein the control information includes an index that points to the Butson-type precoder from a Butson precoder codebook.

15. The method of claim 11, wherein the wireless message includes a demodulation reference signal (DMRS) precoded by the Butson-type precoder and by a singular value decomposition (SVD) precoder.

16. The method of claim 11, wherein decoding the wireless message further comprises:
applying a minimum mean square error (MMSE) equalizer to the wireless message based on the wireless message being precoded by a singular value decomposition (SVD) precoder, wherein the MMSE equalizer outputs a precoded signal that is precoded by the Butson-type precoder.

17. The method of claim 16, wherein decoding the wireless message further comprises:
transforming the precoded signal by a Hermitian of the Butson-type precoder, wherein transforming the precoded signal results in a decoded version of the wireless message.

18. The method of claim 17, wherein a bias removal operation is performed prior to transforming the precoded signal by the Hermitian of the Butson-type precoder.

19. The method of claim 11, wherein the Butson-type precoder is configured to equalize signal-to-noise ratios (SNRs) across multiple layers of the transmission channel.

20. An apparatus for wireless communication, comprising:
means for receiving, from a transmitter device, control information that indicates a Butson-type precoder used to encode one or more wireless messages for transmission via a transmission channel;
means for receiving, from the transmitter device via the transmission channel, a wireless message from the one or more wireless messages; and
means for decoding the wireless message in accordance with the Butson-type precoder indicated by the control information.
